(19) United States
(12) Patent Application Publication
(10) Pub. No.: US 2026/0241661 A1
(43) Pub. Date: Aug. 20, 2026

(54) RECYCLABLE WATERPROOF COMPOSITE FABRIC

(71) Applicant: Nemo Equipment, Inc., Dover, NH (US)

(72) Inventors: Patrick McCluskey, Lee, NH (US); Gabriel Rosenbrien, Somersworth, UM (US); Noah James Pitchforth, Arundel, ME (US); Camon Brensinger, Stratham, NH (US)

(73) Assignee: Nemo Equipment, Inc., Dover, NH (US)

(21) Appl. No.: 18/756,423

(22) Filed: Jun. 27, 2024

Related U.S. Application Data
(60) Provisional application No. 63/523,494, filed on Jun. 27, 2023.

(51) Int. Cl. B32B 5/02; B32B 7/12; B32B 27/12; B32B 27/36; D03D 15/283

(52) U.S. Cl. CPC B32B 5/024; B32B 7/12; B32B 27/12; B32B 27/36; D03D 15/283; B32B 2250/02; B32B 2262/0284; B32B 2307/518; B32B 2307/584; B32B 2307/712; B32B 2307/718; B32B 2307/72; B32B 2307/7376; B32B 2439/06; D10B 2505/10; D10B 2505/18

(57) ABSTRACT

A recyclable composite fabric which is light weight, water repellent and/or waterproof, resistant to sagging or other stretching under wet or humid conditions, and durable based on the unique combination of a woven base layer and a second layer including a film or a coating layer, wherein the composite fabric includes a polyester material. In one embodiment, the composite fabric include an adhesive layer interposed between a woven base layer and a film layer. The finished composite fabric can be formed of recycled materials and is itself recyclable.

### CROSS-REFERENCE TO RELATED APPLICATION

This application claims priority from U.S. Provisional Patent Application No. 63/523,494 titled “RECYCLABLE WATERPROOF COMPOSITE FABRIC”, which was filed on Jun. 27, 2023, which is incorporated fully herein by reference.

### TECHNICAL FIELD

The present invention relates to woven fabrics and textiles, and more particularly to a recyclable waterproof composite fabric and textile for outdoor use and equipment including, for non-limiting examples, tents, backpacks, gear carriers, tote bags, grill covers and other basic outdoor equipment.

### BACKGROUND INFORMATION

Fabrics or textiles for backpacking tents and/or backpacks, and other fabric-based outdoor recreational equipment are typically made from woven fabrics or textiles made of various materials covered with a waterproof polyurethane or silicone coating, layer, film, or laminate. The typical lightweight fabrics may not be sufficiently durable for rugged outdoor use. In addition, the typical fabrics may stretch when wet and lead to sagging. Moreover, polyurethane coated woven fabrics or textiles characteristic of conventional backpacking tents and/or backpacks, and other fabric-based outdoor recreational equipment are generally not constructed of recyclable materials. The typical construction methods result in a mix of materials that are incompatible with each other in current recycling systems, and the materials are typically combined such that separation of such materials is unfeasible. There is a need for recyclable fabrics or textiles for outdoor use which offer simultaneously the features of light weight, durability, water resistance or preferably water proofing, and low stretching particularly under wet conditions.

### SUMMARY OF THE INVENTION

The invention features a recyclable composite fabric comprising a woven base layer and at least one second layer, wherein the composite fabric comprises a polyester material; and wherein at least a portion of the polyester material is a recyclable. The second layer includes at least one of a film layer and a coating layer. The woven base layer includes a pattern of a plurality of interwoven yarns. In one non-limiting embodiment, the composite fabric comprises an adhesive layer disposed between the woven layer and a film layer. In a preferred embodiment, the adhesive layer includes a polyester adhesive material.

For purposes of the present invention:
the term polyester is used interchangeably with the term Polyethylene Terephthalate (PET);
   the term “recyclable” refers to the ability of a material to be converted into the same material or chemically analogous material by any means including but not limited to mechanical and/or chemical means;
the term “film” refers to (a) thermoplastic polymer resin material(s) which has/have an independent structure with a select thickness and in-plane dimensions which are larger than the select thickness;
the term “coating” refers to (a) thermoplastic material(s) which is/are applied in a liquid form at a select temperature, and which solidify upon cooling;
the term “adhesive” refers to a polymer or copolymer thermoplastic or thermoset resin material having properties for permanently or semi-permanently fastening one or more materials; the terms “lamination” and/or “laminated” refers to the process whereby a pre-prepared polymer or copolymer resin film layer is bonded with one or more adjoining materials using one or more adhesives compounds, heat, pressure or a combination of the foregoing; and
   the term “waterproof” refers to a material, fabric or textile which does not allow water to flow through the material below a minimum pressure threshold of 1000 mm water.

Standard outdoor recreational equipment fabrics contain nylon, polyurethane, or a nylon-polyurethane mixture, where such polymers typically have water absorption rates per 24 hours of 1.6-1.9 weight % for nylon and 0.4-1.3 weight % for polyurethane according to test standard ASTM D570. In comparison, the composite fabric featured in the present invention has a lower water absorption rate of 0.1-0.2 weight % per 24 hours according to the ASTM D570 standard based on the base polymer including a polyester material and a homogeneous plastic sheet sample substantially corresponding to a film layer having dimensions of 60 mm×60 mm×1 mm. In one non-limiting embodiment, the composite fabric includes a base woven layer and a film layer, and an adhesive layer disposed therebetween where the layers are bonded together using a hot melt lamination. The composite fabric including the hot melt laminated layer construction or including the woven base/coating layer construction can easily achieve 1,200 mm water resistance levels similar to polyurethane coatings such that the composite fabric can sustain 1,200 mm of water on top of the layer before at least three drips of water pass through the composite fabric. The composite fabric including hot melt laminated layer construction can easily achieve or exceed 10,000 mm water resistance level where a BoPET (biaxially oriented polyethylene terephthalate) or co-polyester film layer is laminated to a polyester woven base layer using a polyester hot melt adhesive. The composite fabric has a weight per area in grams per square meter or GSM in range of 20 GSM to 400 GSM. The plurality of yarns have a selected denier range in a range of 9 denier to 1200 denier.

### BRIEF DESCRIPTION OF THE DRAWINGS

These and other features and advantages of the present invention will be better understood by reading the following detailed description, taken together with the drawings wherein:

FIG. 1 is a schematic representation of the composite fabric including a woven base layer a film layer and an adhesive layer interposed therebetween according to a non-limiting embodiment of the invention;

FIG. 2A a schematic representation of the woven base layer according to a non-limiting embodiment of the invention;

FIG. 2B a schematic representation of the woven base layer according to a non-limiting embodiment of the invention;

FIG. 3A is a schematic representative of the composite fabric including woven base layer and a film layer according to a non-limiting embodiment of the invention;

FIG. 3B is a schematic representative of the composite fabric including woven base layer and a coating layer applied in liquid form; and

FIG. 3C is a schematic representative of the composite fabric including woven base layer and a coating layer applied in liquid form of FIG. 3B which solidifies upon cooling according to a non-limiting embodiment of the invention.

### DETAILED DESCRIPTION OF THE PREFERRED EMBODIMENTS

The present invention features a recyclable and generally waterproof composite fabric including a woven base layer and a second layer which includes a film layer or a coating layer, and wherein the composite fabric comprises a polyester material; and wherein at least a portion of the composite fabric is recyclable. The woven base layer includes a pattern of a plurality of interwoven yarns. In one non-limiting embodiment, the composite fabric includes an adhesive layer disposed between the woven base layer and the film layer. In a preferred embodiment, the adhesive layer includes an adhesive polyester material.

The composite fabric is designed for production as a recyclable lightweight, durable, waterproof fabric which can then be manufactured into various products including, but not limited to, backpacking tents, backpacks, gear carrier or tote bags, grill covers and/or other product or covering particularly for outdoor use. For purposes of this application, the terms “fabric(s)” and “textile(s)” are used interchangeably.

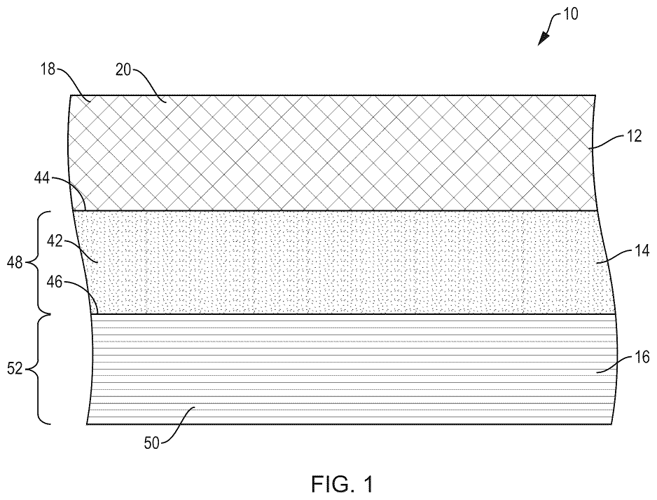

In one embodiment, the invention features a composite fabric 10 as shown in FIG. 1. The composite fabric 10 comprises a woven base layer 12 and a film layer 16. An adhesive layer or adhesive material 14 is interposed or threaded between the woven base layer 12 and the film layer 16.

The adhesive layer or adhesive material 14 can be any type of appropriate adhesive including, but not limited to, a solvent-based adhesive, a water-based adhesive, and/or a hot-melt adhesive. The method of application of the adhesive and joining of the woven base layer and the film layer depend on the type and form of the adhesive.

The solvent-based or water-based adhesives can be applied to the woven base layer and/or the film layer when the adhesive is in a fluid state and subsequently, the adhesive can be cured to form a solid. The solvent-based or water-based adhesives can be applied to the woven base layer and/or the film layer using methods such as, for non-limiting examples, knife coating, rolling, submersion, and/or spraying methods prior to the woven base layer and the film layer being pressed and/or fastened or adhered together.

The hot-melt adhesive can be applied as a powder, through extrusion, and/or as a film. Heat and/or pressure can be applied to join the woven base layer, the hot-melt adhesive and the film layers together. When disposed on the woven base layer 12, the hot-melt adhesive fills the voids or interstices of the woven base layer 12 and serves to laminate or otherwise fix the film layer 16 to the woven base layer 12 such that the woven base layer, the film layer and the adhesive form laminated layers.

The woven base layer 12 is woven from yarns 18. The yarns 18 include between 50 % and 95 % by weight of the composite fabric 10.

The polyester material of the composite fabric has a PET content in range of 80 % to 100 % by weight. The composite fabric according to the present invention is designed and well suited for providing a fabric having a wide total weight per area in grams per square meter (GSM) in a range of 20 GSM to 400 GSM. In select embodiments, such as, for non-limiting examples, in embodiments including backpacks, the inventive composite fabric typically has a total weight per area in a range of 40 to 400 GSM, and preferably a total weight per area in a range of 50 to 250 GSM. In other select embodiments, such as, for non-limiting examples, in embodiments including lightweight tent fabrics, the inventive composite fabric typically has a total weight per area in a range of 20 to 200 GSM, and preferably a total weight per area in a range of 20 GSM to 50 GSM.

The yarn 18 of the woven base layer 12 preferably has a denier or D range of between to 9 D to 1200 D depending upon the application. The Denier or D range is a well-known unit of measurement corresponding to the linear density of weight based on the length and weight of a yarn or fiber. For non-limiting examples, the inventive composite fabric designed for a lightweight backpack fabric might typically utilize yarns having a denier range of 50 D to 1200 D, and preferably a denier range of 68 D to 600 D, while the inventive composite fabric for a lightweight tent fabric typically would incorporate yarns having a denier range of 9 D to 1200 D, and preferably a range of 15 D to 300 D.

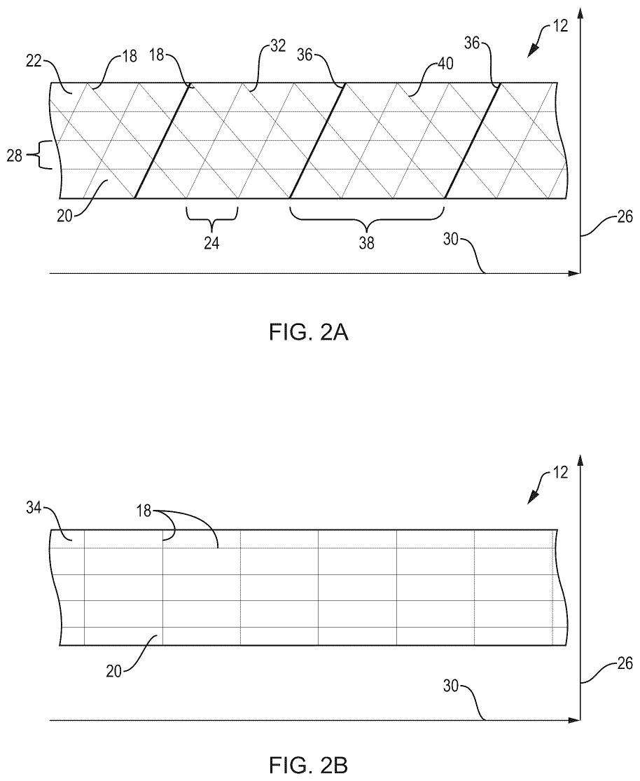

In a preferred embodiment, the woven base layer 12 comprising yarns 18 are woven in an interlocking configuration 20 including a crosshatch pattern 22 as shown in FIG. 1 and FIG. 2A. A range of 90 %- 100 % of the yarns of the woven base layer will include the polyester material. The interval 24 between yarns running in the warp direction, that is substantially along the length of the fabric, and the interval 30 between the yarns running in the weft direction, that is substantially along the width of the will be substantially 0 as the polyester yarns will be disposed substantially next to one another unless an different yarn type, such as, for a non-limiting example, an ultra-high-molecular-weight polyethylene or UHMWPE yarn is interspersed into the polyester weave as for example, a rip stop or other type of reinforcement yarn as further discussed below.

The interlocking configuration 20 corresponds to a “plain weave” type configuration where yarns in the weft direction are passed under and over yarns running consecutively in the warp direction.

In another embodiment, the woven base layer 12 comprises yarns 18 woven in an interlocking configuration 20 including a cross hatch pattern 34 as shown in FIG. 2B.

In still other embodiments, the yarns 18 of the woven base layer 12 are woven in interlocking configurations including alternative patterns where the yarns are disposed in the warp and weft directions at angles other than those shown in FIGS. 2A and 2B, as known to those of ordinary skill in the art.

In another embodiment, the woven base layer 12 may incorporate a ripstop weaving technique that renders the composite fabric more resistant to tearing and ripping, as shown in the non-limiting embodiment illustrated in FIG. 2A. Thicker reinforcement yarns 36 may be interwoven at regular ripstop intervals in the interlocking configuration 20. The ripstop interval 38 between two adjacent reinforcement yarns 36 disposed substantially in the warp direction 26, as shown in FIG. 2A, may be in a range of between 1 mm to 20 mm, and preferably may be in a range of between 2 mm to 10 mm. The reinforcement yarns 36 have a diameter width 40 in a range of between 30 microns to 300 microns, and preferably in a range of between 39 microns to 175 microns. Although FIG. 2A illustrates the thicker reinforcement yarns 36 are interwoven at regular ripstop intervals disposed substantially in the warp direction 26, in other non-limiting embodiments, reinforcement yarns 36 may be disposed or interspersed among smaller diameter yarns 18 disposed substantially in the weft direction or disposed or interspersed substantially in both the warp and the weft directions.

The woven base layer 12 of the composite fabric 10 of the invention has a yarn density corresponding to the number of yarns arranged within or per inch in the warp direction 26 of between 25 to 250. The woven base layer 12 of the composite fabric 10 of the invention has a yarn density per inch in the weft direction 30 of 25 to 250.

The woven base layer 12 has a rate of water absorption in a range of between 0.1 to 0.2 weight % per 24 hours. The woven base layer 12 has a water-induced elongation rate in a range of 0.0% to 0.2%.

In an embodiment, the woven base layer 12 include yarns formed from recycled material. In a preferred embodiment, the polyester material of the composite fabric includes recycled polyester material in a range of 0 % to 100 % by weight of the polyester material. In other preferred embodiments, the adhesive layer including for a non-limiting example, a hot-melt adhesive, and/or the film layer can be made of recycled material in a range of 0 % to 100%.

The adhesive layer 14 of the inventive composite fabric 10 is constructed of an adhesive material 42 having a rate of water absorption in a range of 0.1 to 0.2 weight % per 24 hours. The result of a peel test conducted in accordance with ASTM D903 used to determine the bond strength or force required to de-bond or detach adjoining layers from the adhesive layer is in a range of 0.25 to 3.00 kg/cm. The adhesive layer 14 is configured to adhere to the woven base layer 12 to the film layer 16. The adhesive layer 14 has a thickness 48 in a range of 3 to 30 microns, and preferably in a range of between 4 to 9 microns; and a percentage of weight of the composite fabric in a range of 5 to 50 and preferably in arrange of 7.5 to 15. A non-limiting example of the adhesive material 42 is a solvent-based PET adhesive.

The film layer 16 of the inventive composite fabric 10 includes a polyester material 50 having a rate of water absorption in a range of 0.1 to 0.2 weight % per 24 hours. The water repellency rating of the film layer is in a range from 50 to 100 according to AATCC TM 22 Water Repellency: Spray Test, and depends on whether the film layer is used on the front or back side of the composite fabric, the inherent hydrophobicity and composition of the film layer, the manufacturing process for the film layer and/or the composite fabric, and any surface treatment applied to the film layer. Such surface treatment of the film layer may include changes to the surface topology such as, for example, surface roughness, changes to the composition of the surface, and addition of materials such as silicone or other hydrophobic materials to the surface of the film layer. The film layer has a durability to abrasion which is characterized by ASTM D3389-16, Taber Abrader with Abrasive Wheel: CS-10 and Loading of 500 g, and the minimum acceptable number of abrasion cycles is 300 for the polyester film layer under these conditions. The film layer has a thickness 52 in a range of 1 to 50 microns and preferably in a range of 1.2 to 12 microns; and a percentage of weight of the composite fabric in a range of 2 % to 30 % and preferably in a range of 3 % to 20 %. Non-limiting examples of the film layer 12 material is bi-axially oriented PET film or co-polyester PET film.

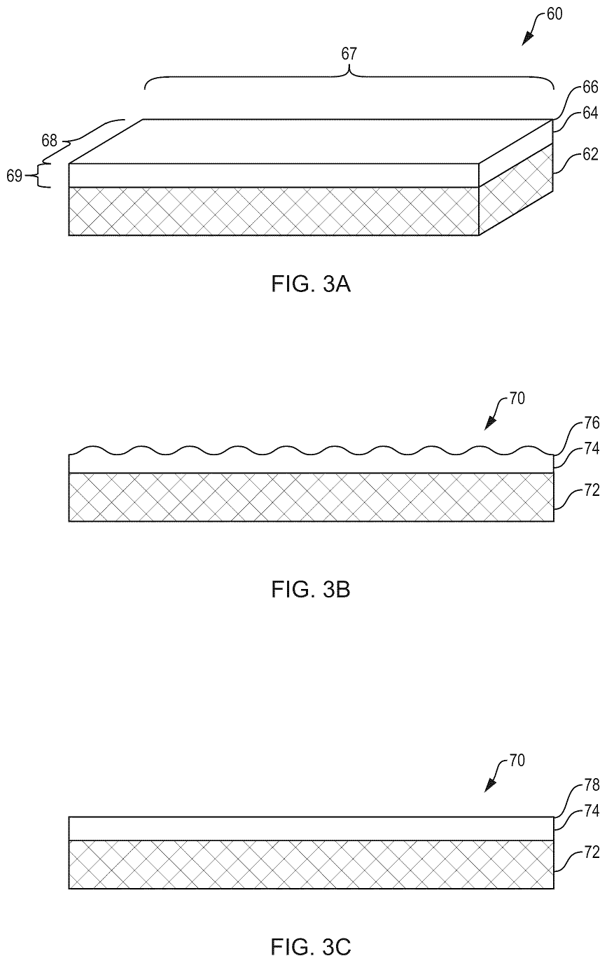

In another embodiment, the inventive composite fabric 60 includes a woven base layer 62 and a second layer 64 including a film layer 66 as shown in FIG. 3A. The in-plane length 67 and in-plane width 68 are larger than the thickness 69 of the film layer 66.

In still another embodiment, the inventive composite fabric 70 includes a woven base layer 72 and a second layer 74 including a coating layer 76 as shown in FIG. 3B. FIG. 3B shows the coating layer 76 applied in a liquid form. Upon cooling, the liquid coating layer 76 solidifies forming a solidified coating layer 78, as shown in FIG. 3C.

The completely assembled composite fabric 10 has a total weight per area in range of 20 GSM to 200 GSM, and preferably in a range of 30 GSM to 150 GSM; a rate of water-induced elongation in a range of 0.0% to 0.2%; and a rate of water absorption in a range of 0.1 to 0.2 weight percent per 24 hours. The relatively light weight of the inventive composite fabric makes it ideal for backpacks and backpacking tents. Products constructed of the inventive polyester fabric will experience less sagging particularly under wet conditions because of the relatively low rates of water-induced elongation and water absorption of the composite material and as an important feature of the invention, the composite fabric 10 can be recycled when no longer needed or serviceable, since polyester is the most recycled plastic material to date. For example, at least a portion of the polyester material of the inventive composite fabric is recyclable having a degree of conversion in a range of 80 % to 100 %. The degree of conversion is measured according to methods known to those of ordinary skill in the art including by the extraction of material by inline mechanical filters, density separation, or vapor pressure differences, among others, while the quality of the output resin can be determined by spectroscopic methods that can determine bond types and mechanical methods that can determine mechanical properties, among other analytical methods.

Thus, the present invention provides a novel and nonobvious composite fabric which is recyclable, light weight, water repellent and/or waterproof, resistant to sagging or other stretching under wet or humid conditions, and durable based on the unique combination of the interior woven base layer coupled with a second layer including a film layer or a coating layer, and further an optional adhesive layer interposed between a woven base layer and a film layer. Additionally, the individual components of the composite fabric are selected so as to be recycled and may themselves include recycled material.

The present invention is not intended to be limited to a device or method which must satisfy one or more of any stated or implied objects or features of the invention and should not be limited to the preferred, exemplary, or primary embodiment(s) described herein. Modifications and substitutions by one of ordinary skill in the art are within the scope of the present invention, which is not to be limited except by the allowed claims and their legal equivalents.

The invention claimed is:

1. A composite fabric comprising:
a woven base layer including a pattern of a plurality of interwoven yarns; and
a second layer including a film layer or a coating layer;
wherein the composite fabric comprises a polyester material; and
wherein at least a portion of the polyester material is recyclable.

2. The composite fabric of claim 1,
wherein the second layer includes the film layer;
the composite fabric further comprising an adhesive layer disposed between the woven base layer and the film layer; and
wherein the adhesive layer comprises a polyester adhesive material.

3. The composite fabric of claim 1, wherein the plurality of interwoven yarns are formed from one or more recyclable materials.

4. The composite fabric of claim 1, wherein the plurality of yarns have a density of 25 to 250 yarns per inch.

5. The composite fabric of claim 1, wherein the plurality of yarns have a selected denier range in a range of 9 denier to 1200 denier.

6. The composite fabric of claim 1, wherein the composite fabric has a total weight per area in a range of 20 grams per square meter or GSM to 400 grams per square meter or GSM.

7. A backpack comprised of the composite fabric of claim 1.

8. The composite fabric of claim 1, wherein the plurality of interwoven yarns have a selected denier range in a range of 50 denier to 1200 denier.

9. The composite fabric of claim 1, wherein the composite fabric has a total weight per area in a range of 40 GSM to 400 GSM.

10. A tent comprised of the composite fabric of claim 1.

11. The composite fabric of claim 1, wherein the composite fabric has a weight per area in a range of 20 GSM to 200 GSM.

12. The composite fabric of claim 1, wherein a range of between 80% to 100% of the polyester material is recyclable.
